(19) United States
(12) Patent Application Publication
(10) Pub. No.: US 2008/0279997 A1
(43) Pub. Date: Nov. 13, 2008

(54) Mehod for processing poultry to reduce or eliminate salmonella

(76) Inventors: Gary L. Nace, Claude, TX (US); Terry L. McAninch, Westminister, CO (US)

Correspondence Address: Thomas H. Young, 5500 Hawthorn Cir., Greenwood Village, CO, 80121, US

(21) Appl. No.: 12/151,826

(22) Filed: May 9, 2008

Related U.S. Application Data
(60) Provisional application No. 60/928,941, filed on May 11, 2007.
(60) Provisional application No. 61/070,453, filed on Mar. 22, 2008.

(51) Int. Cl. A23B 4/12; A23L 3/34

(52) U.S. Cl. 426/332; 426/532

(57) ABSTRACT

A method for reducing the incidence of salmonella in harvested poultry comprising treating the poultry with an effective antimicrobial solution comprising a blend of citric and lactic acids.

This application claims the benefit of U.S. provisional patent applications Ser. No. 60/928,941, filed on May 11, 2007, and Ser. No. 61/070,453 filed on Mar. 22, 2008, which are incorporated by reference herein.

### FIELD OF THE INVENTION

The present invention relates to an improved method for processing poultry in a manner that substantially reduces or eliminates salmonella in the resulting meat products without affecting desirable characteristics of those products, such as their appearance, taste or aroma.

### BACKGROUND OF THE INVENTION

The United States poultry industry processes approximately nine million chickens, turkeys, and other fowl (collectively, “poultry”) annually with a sales value in excess of $20 billion. In recent years, chicken and turkey, for example, have been perceived by some consumers as being healthier and/or less expensive than certain other protein options, such as, red-meat. For these and other reasons, the U.S. poultry industry has been expanding at a rate of 3 to 6 percent annually.

Food safety is the most important issue in the poultry industry. Consumers are constantly reminded that chicken and turkey must be cooked thoroughly and that cooked meat should not contact un-cleaned surfaces, such as cutting boards and countertops, on which the uncooked meat was processed. The reason for this is to avoid salmonella contamination in the chicken or turkey that is consumed.

The majority of live chickens and turkeys have salmonella, and at least two-thirds of the live poultry have “Campylobacter.” Salmonella and Campylobacter are the two leading bacterial causes of food poisoning in the United States. According to the Center for Disease Control, there are 40,000 reported cases of salmonella poisoning and 600 deaths annually. The CDC estimates that the actual number of salmonella cases is approximately 30 times the number of reported events. Obviously, it is highly desirable for producers to deliver processed poultry with minimal incidence of these bacteria. For a number of reasons, however, government regulations allow up to a 50% incidence of salmonella on uncooked poultry sold for consumption. Assuming that the poultry is properly prepared for eating, there should be minimal risk of illness from bacterial poisoning. Obviously, from the statistics quoted previously, reliance on proper cooking and preparation by consumers is not dependable. In February 2006, the USDA announced an initiative to further reduce the incidence of salmonella in meat and poultry.

While it is possible to promulgate regulations mandating a zero percent tolerance, i.e., incidence, for salmonella in poultry leaving a production plant, no known process exists at the present time for achieving that lofty and desirable goal.

Various chemical treatments have been tried. A survey of the poultry industry in March 2006 revealed the use of a number of chemicals in “online processing” to reduce salmonella. In the order of most to least used, those chemicals included: acidified sodium chlorite; trisodium phosphate; chlorine dioxide; hypochlorous acid; organic acids, peracetic acid; cetylpyridinium chloride; citric acid and HCL; bromine; sodium metasilicate; and electrolyzed oxidative. Organic acids approved for use include lactic, acetic and citric acids. Acetic acid, however, has a flavor/taste issue. To mitigate that problem and issues of poultry discoloration, acetic acid must be used at low concentrations that significantly diminish the antimicrobial efficacy. Also, acetic acid is flammable. Citric acid, on the other hand, is generally believed not to be a particularly good antimicrobial. Also, it is normally available in a crystalline form, is difficult to deal with and involves more handling for the user. To the extent that citric acid is available in solution, it is not at the correct concentration level and would still involve additional handling. Thus, lactic acid, which is a good antimicrobial, is currently the most frequently employed of the organic acids.

However, none of the various chemicals listed above and others have been able to achieve a zero tolerance efficacy level for salmonella. Efforts to improve efficacy levels through the application of larger doses of chemical have been accompanied by discoloration of the meat and “off-smells” or tastes that are offensive or objectionable to potential purchasers and consumers. Many of the chemical treatments are quite expensive even at dosage levels that barely meet the 50% incidence level.

Accordingly, there is a significant industry and public need for improved processes that can inexpensively and effectively reduce the incidence of salmonella and other pathogens in poultry products leaving the production plant and that can do so without adversely affecting the color, smell or taste of the poultry.

### SUMMARY OF THE INVENTION

It has now been found that these needs can be met by processing poultry in the harvesting plant with a buffered blend of lactic acid and citric acid at appropriate conditions. Contrary to traditional thing to employ large concentrations of chemicals for short periods of time, it has now been found that more desirable results can be achieved using low concentrations. The blend of lactic acid and citric acid can be employed at one or more steps during processing of the poultry and can be employed in various manners, e.g., spray, mist, bath, dip, etc.

In a preferred embodiment of the invention, the acid blend is applied to the carcasses in two separate applications. The first is a spray after the feathers are plucked from the bird, i.e., pre-evisceration. The second is a “dip” or bath that is employed post-evisceration and prior to chilling.

Experimental tests of the present invention have verified that it is very effective in reducing the incidence of salmonella in the poultry product well below the 50% tolerance level. The process of the present invention does not cause discoloration of the poultry or impart an off-taste or smell to the poultry products. Also, it significantly reduces the presence of other pathogens in processed poultry.

### BRIEF DESCRIPTION OF THE DRAWINGS

FIG. 1 is a schematic depicting a typical prior art process for processing poultry.

FIG. 2 is a schematic depicting one presently preferred embodiment of the present invention for processing poultry.

### DETAILED DESCRIPTION OF THE INVENTION AND A PREFERRED EMBODIMENT

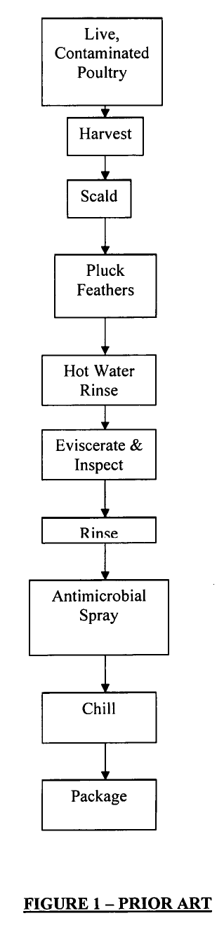

FIG. 1 depicts a typical production process for harvesting and processing poultry for market. Live chickens are brought into the production plant in crates and are unavoidably covered in part with feces and salmonella. The chickens are removed from the crates and hung upside down. In that position their throats are cut, so that the blood can drain thoroughly. The carcasses are then put in a scalding tank where they are treated for about 5-7 minutes with water at about 138-142 degrees F. On some occasions, an alternative low temperature scalding process is carried out at approximately 124 F. The scalding prepares the carcass for removal of the feathers and kills bacteria. On the other hand, the scalding tank often promotes cross-contamination of poultry entering the tank by contact with water contaminated by bacteria from previously processed poultry. The poultry are then sent to one or more “pluckers,” available in various configurations, for removal of the feathers. The de-feathered carcasses are then rinsed with potable water, also at about 138-142 degrees F. The hot water rinse assists in final removal of any residual feathers.

The carcasses are then placed on an automated evisceration and inspection line. Along the line the poultry are eviscerated, any remaining heads are removed, and parts that appear visibly to be contaminated are cut off. The carcasses are then subject to a “final” rinse with water at ambient temperature.

At this point, the carcasses are subjected to “antimicrobial control.” Typically, this is a chemical spray applied for about thirty seconds. As previously mentioned, typical chemicals include acidified sodium chlorite, peracetic acid, acidified calcium sulfate, chlorine bleach (either calcium or sodium hypochlorite) or another “processing aid” approved by the USDA-FSIS.

After the antimicrobial treatment, the treated carcasses pass through a chiller where the processed chickens are subject to cooling with cold air or in ice water for a sufficient time to bring their temperature down to about 35 to 40° F. After chilling, the carcasses are either sold as “whole” poultry or are cut up and sold in various assortments of “parts.”

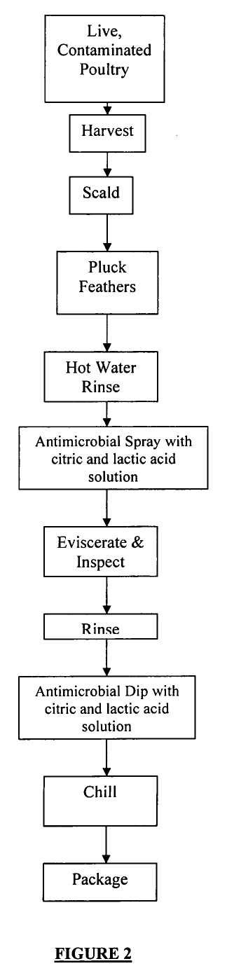

In contrast, FIG. 2 depicts one presently preferred embodiment of the present invention. The initial steps are essentially the same as in FIG. 1. However, immediately after the plucking step and the hot water rinse, the de-feathered carcasses are subjected to an antimicrobial spray. For example, the spray can employ a 2.5 wt. % aqueous solution of a mixture of citric and lactic acids as described below. (As used herein, the concentration of antimicrobial agent or ingredients therein is specified in wt./wt.%.) The spray is applied for about 5 to 10 seconds to each carcass as the carcasses pass through a spray booth. The concentration can vary from approximately 1% to 2.5 wt. %. Using this process step (i.e., antimicrobial spray following plucking) alone resulted in a reduction of about 30% in the incidence of salmonella on carcasses treated to this same point (i.e., hot water rinse after plucking) in the conventional process of FIG. 1.

In an alternative and sometimes preferred embodiment of the present invention, the antimicrobial spray is employed after plucking but before the hot water rinse. In other words, the antimicrobial spray and hot water rinse can be employed in either order.

It is believed that the microbial reduction is in large part due to the application of the blend of citric and lactic acids. However, the application of antimicrobial agent at this point in processing is not a typical part of the poultry production process. It appears that the scalded and plucked carcass may be particularly susceptible to antimicrobial treatment at this stage.

Following this initial antimicrobial treatment, the carcasses are then placed on the evisceration line and processed as mentioned previously. However, it has now been found that it is especially efficacious to use an antimicrobial agent comprising a blend of citric and lactic acids in the post-evisceration antimicrobial control. Again, the concentration of the acid blend may be approximately 1% to 2.5 wt % of the aqueous solution on a weight basis. As shown in FIG. 2, a preferred method of applying the mixture of acids is to use a “dip.” Preferably, the carcasses are placed in the dip for about 5-10 seconds to approximately one minute. It is believed that there is better contact of the carcass with the antimicrobial agent in the dip. However, an antimicrobial spray would also be beneficially employed as an alternative. Preferably a solution of about 1 to about 2.5 wt % of the mixture of citric and lactic acids is employed. The bath should be monitored to make sure that the concentration remains in this range. If the level falls below 2% the antimicrobial agent may not be as effective as desired. If the concentration exceeds 2.5% the carcasses may develop an undesirable gray color and objectionable odor. One way to help control the concentration is to slowly feed, e.g., “drip,” antimicrobial solution into the dip tank. Alternatively, the antimicrobial solution can be added to the tank and blended with water to the desired concentration. In either event, it is desirable to monitor the concentration about every 15-20 minutes to ensure that the concentration is maintained in the proper level. The use of the antimicrobial dip results in a 90% reduction in salmonella, i.e., 90% of the poultry carcasses with salmonella before treatment will be salmonella-free after treatment.

Following the antimicrobial dip, it has also been found desirable to use a rinse employing potable water or any other USDA approved final rinse step, such as chlorinated water, within the approved concentration(s). In the case of a chlorinated water rinse, a typical concentration is between about 20-50 ppm. Each carcass should be subjected to the spray for between about 1 to 6 seconds. After the treatment with the aqueous chlorine spray, the carcasses are then sent into an air chiller. In the event that the production facility uses an ice bath for chilling, the chlorine (or other USDA approved substance at proper concentration(s)) can be added to the ice bath rather than using a separate spray.

The preferred antimicrobial agent used in the present invention comprises a blend of lactic and citric acids which are buffered by potassium hydroxide. It is likely that some potassium citrate and potassium lactate are produced as a result and may be present in the aqueous mixture as applied to the poultry depending on the mixing procedure and timing. In one embodiment of the present invention, the antimicrobial agent is a mixture of citric and lactic acids sold by Purac America, Inc., Lincolnshire, Ill., under the designation “CL 21/80.” CL21/80 contains lactic acid and lactate in an amount of approximately 43-49 wt % and citric acid and citrate in an amount of approximately 29-35 wt %. The product is slightly buffered with potassium hydroxide so that it provides a pH 2.0-2.2 in a 10% solution in water. Potassium is present in the product in an amount of about 1.2-1.5%. Other blends of citric and lactic acids could be employed with citric to lactic acid ratios ranging from about 1:8 to about 1:1 by weight. The preferred range of ratios is about 1:7 to about 1:3 citric acid to lactic acid.

CL 21/80 or other blends of citric and lactic acids may be employed in solution in amounts ranging from about 1% to approximately 2.5 wt 5. The lower range is the minimum amount required for anti-microbial efficacy. Indeed, it has been found that at concentrations much above 2.3 wt %, there is a tendency for the microbial treatment to result in significant discoloration of the poultry or an off-taste or smell.

The antimicrobial mixture of citric and lactic acids may be applied following the plucking or following evisceration and prior to chilling or in both of these locations. It is also possible to use the antimicrobial treatment at other places in the processing of poultry. Application may occur for approximately 1 to 60 seconds, but application times of about 1-5 seconds are preferred.

As indicated, for example, by the following tests the process of the present invention provides a significant reduction in the incidence of salmonella in harvested poultry and reduces the presence of other pathogens.

### EXAMPLES

### Example 1

A test was performed on commercially processed chicken carcasses to determine the antimicrobial efficacy of a post-evisceration dip employing a solution of citric acid and lactic acid (i.e., Purac CL21/80) in a post-evisceration, dip tank. The production line from which the sample carcasses were obtained utilized a process as shown in FIG. 1.

Seventy-five chicken carcasses were removed from the production line post evisceration. Twenty-five poultry were evaluated at this stage by a USDA certified laboratory for aerobic plate counts (“APC”), generic E-coli., and the presence or absence of Salmonella spp. Of the twenty-five carcasses, ten were evaluated for APC and E-Coli and all twenty-five for Salmonella spp.

The remaining fifty carcasses were then processed in a dip tank containing a solution of Purac CL21/80. The solution was monitored and maintained within a target concentration of 1.80% to 2.00%. The actual concentrations in the dip tank varied from 1.80% to 2.04% throughout the study period. The concentration was monitored by periodic taking a sample of a known size from the solution and titrating the sample on site. The chicken carcasses were treated in the dip for approximately 60 seconds. Ten chicken carcasses were then evaluated for APC and E-coli (10 carcasses), and all 25 carcasses were evaluated for the presence of Salmonella spp.

The remaining twenty-five chicken carcasses were sent to the chiller and then examined for Salmonella spp. (25 carcasses).

The chicken carcasses were rinsed in accordance with the Microbiology Laboratory Guidebook, Chapter 4.03, Section 4.5.7 Whole Bird Rinses, published by the United States Department of Agriculture (“USDA”). The carcasses were rinsed with 400 ml of Butterfield's Phosphate Diluent as described in the note; this was done in order to also evaluate APC and generic E. coli values from the rinse solution for each bird.

Upon arrival at the laboratory the chicken rinses were processed for the evaluation of APC, generic E. coli and Salmonella spp. APC were prepared and evaluated in accordance with the Food and Drug Administration's Bacteriological Analytical Manual (“FDA-BAM”), 8^{th} Edition, Revision A, 1998. Generic E. coli were prepared and evaluated in accordance with AOAC Official Method of Analysis 991.14. AOAC Official Method of Analysis 996.08 was performed to analyze the chicken rinses for the presence or absence of Salmonella spp. The data and cumulative results for APC and E-coli pre-dip and post-dip are shown in Table I. The data for Salmonella spp. pre-dip, post-dip and post chiller are shown in Table II. (The data for APC and E. coli in a given row in the table represents the test data for a single sample bird pre-dip and a single sample bird post-dip.)

TABLE 1

| | APC | APC | E. coli | E. coli |
|---|---|---|---|---|
| | (pre-dip) | (post-dip) | (pre-dip) | (post-dip) |
| | Log order | Log order | Log order | Log order |
| | CFU/mL | CFU/mL | CFU/mL | CFU/mL |
| | 5.56 | 2.94 | 2.81 | 0.00 |
| | 5.68 | 2.99 | 3.04 | 1.04 |
| | 5.79 | 3.08 | 2.40 | 0.00 |
| | 5.40 | 2.81 | 3.15 | 0.95 |
| | 5.49 | 2.72 | 3.11 | 0.78 |
| | 5.54 | 2.89 | 2.84 | 0.00 |
| | 5.46 | 2.77 | 2.92 | 0.30 |
| | 5.83 | 3.00 | 2.75 | 0.00 |
| | 5.62 | 2.83 | 3.00 | 0.60 |
| | 5.43 | 2.81 | 2.57 | 0.00 |
| Average Log 10 | 5.58 | 2.88 | 2.86 | 0.37 |

The lactic acid blend demonstrated a 2.32 to 3.12 log 10 reduction in aerobic plate, counts and generic E. coli counts showed a 1.36 to 3.15 log 10 reduction (See Table 1.) Five of the chicken rinses had generic E. coli counts of less than 10 colony forming units/ml (CFU/ml); these are represented by the 0.00 in the E. coli (post-lactic) column of Table 1. These figures represent the bacterial loads after the IOBW and prior to the chilling of the chicken carcasses.

TABLE 2

| | # Positive | % Positive | # Negative | % Negative |
|---|---|---|---|---|
| Pre-dip | 23 | 92 | 2 | 8 |
| Post-dip | 1 | 4 | 24 | 96 |
| Post-Chill | 1 | 4 | 24 | 96 |

Of the twenty-five carcasses rinsed at the pre-antimicrobial blend interval (after IOBW, prior to dip tank) twenty-three of the chicken rinses tested positive for Salmonella spp. After exposure to the antimicrobial blend in the dip tank, (post-lactic, pre-chill) only one of the chicken rinses tested positive, with the remaining twenty-four carcasses being negative for Salmonella spp. At the post-chill interval twenty-four out of the twenty-five tested negative, with only one being positive (See Table 2.). Although, no further confirmation testing was performed, the screen procedure used in this study has a high sensitivity for meat products with 99% specificity. Certain strains of Citrobacter or Hafnia have showed some cross-reactivity with the screening method utilized.

The results from this study indicate that the use of a citric acid/lactic acid blend in a dip tank system is effective in the reduction of pathogenic bacteria including salmonella.

The following additional experiments also support the efficacy of the citric acid/lactic acid blend in the reduction of pathogenic bacteria

### Example 2

Tests were performed to determine the efficacy of using a mixture of citric acid and lactic acid in solution on commercially processed chickens at various points in the poultry harvesting process. The solution contained approximately 2.5% of Purac CL21/80.

Sample chicken carcasses were obtained from a production line utilizing a process as shown in FIG. 1. Sample carcasses were removed from the production process and were treated with the antimicrobial solution as shown in Table 3 and the following description. Spray times were what it took to completely cover the bird with solution and dip times were what it took to manually dunk the bird in a bucket and pull it out. In each case contact time was about 1 to 6 seconds.

Sample 16 (pre-evisceration) was placed in a 5 gallon bucket containing a 2.5% solution of CL21/80, i.e., the concentration used in all the sample treatments. The sample was dipped down and then brought back to the surface for a residence time of about 1 to 6 seconds in the solution.

Sample 18 was sprayed with a solution of CL21/80 using a pump sprayer as the carcass was rotated and covered well with the solution. The dip was the same as for sample 16.

Sample 20 was a control sample taken after the plucker.

Sample 21 was a control sample taken just before entering the chiller. It had been sprayed using a combination of citric acid and sodium chlorite sold under the trademark Sanova® by Alcide Corporation, Redmond, Wash. and now a part of Ecolab, Inc., St. Paul, Minn.).

Sample 22 (post-evisceration) was taken from a different place on the line, but treated the same as sample 18.

Sample 23 was sprayed with Purac CL21/80 pre-evisceration and dipped in a 20 ppm. chlorine dioxide solution post-evisceration.

TABLE 3

| (Sample | Treatment with | | | Results |
|---|---|---|---|---|
| Carcass) | 2.5% CL 21/80 | Analysis | Method | CFU/gram |
| 16 | Single dip - | Aerobic Plate | FDA | 42,000 |
| | pre-evisceration | Count | BAM | |
| 16 | Single dip - | Coliform | AOAC | 90 |
| | pre-evisceration | | | |
| 18 | Pre-evisceration spray | Aerobic Plate | FDA | <10 |
| | and post-evisceration | Count | BAM | |
| | dip | | | |
| 18 | Pre-evisceration spray | Coliform | AOAC | <10 |
| | and post-evisceration | | | |
| | dip | | | |
| 20 | Control - no treatment | Aerobic Plate | FDA | 260,000 |
| | | Count | BAM | |
| 20 | ″ | Coliform | AOAC | 860 |
| 21 | ″ | Aerobic Plate | FDA | 130,000 |
| | | Count | BAM | |
| 21 | ″ | Coliform | AOAC | 1,200 |
| 22 | Post-evisceration spray | Aerobic | FDA | 49,000 |
| | | Plate Count | BAM | |
| 22 | ″ | Coliform | AOAC | 400 |
| 23 | Pre-evisceration spray | Aerobic Plate | FDA | 170,000 |
| | and post evisceration | Count | BAM | |
| | chlorine dioxide dip | | | |
| 23 | Pre-evisceration spray | Coliform | AOAC | 780 |
| | and post evisceration | | | |
| | chlorine dioxide dip | | | |

### Example 3

A test was performed to determine the efficacy of using a 2.5% solution of citric acid and lactic acid (i.e., Purac CL21/80) as a spray on commercially processed chicken carcasses pre-evisceration. Sample carcasses were removed from the production process and sprayed for approximately 1 to 6 seconds with the antimicrobial solution. The results are shown in Table 4. The APC was determined utilizing the FDA BAM method. All other tests results were obtained using AOAC.

TABLE 4

| | | | Mold | |
|---|---|---|---|---|
| (Sample | Aerobic Plate Count | Coliform | Count | Yeast Count |
| Carcass) | (CFU/mL) | (CFU/mL) | (CFU/mL) | (CFU/mL) |
| 1 | 900 | 80 | <10 | 20 |
| (CL21/80 A) | | | | |
| 2 | 1,800 | 60 | <10 | <10 |
| (CL21/80 B) | | | | |
| 3 | 23,000 | 620 | 20 | <10 |
| (Control A) | | | | |
| 4 | 146,000 | 810 | 30 | 10 |
| (Control B) | | | | |

1. A method for reducing the incidence of salmonella in harvested poultry comprising treating the poultry with an effective antimicrobial solution comprising a blend of citric and lactic acids.

2. The method of claim 1 in which the antimicrobial solution contains about 1 to 2.5 wt % of citric and lactic acids.

3. The method of claim 2 in which the ratio of citric acid to lactic acid in the antimicrobial solution is from about 1:8 to about 1:1 by weight

4. The method of claim 2 in which the ratio of citric acid to lactic acid in the antimicrobial solution is about 1:7 to about 1:3 by weight.

5. The method of claim 2 in which the ratio of citric acid to lactic acid in the antimicrobial solution is about 1:3 by weight.

6. The method of claim 3 in which the treating of the poultry with the antimicrobial solution of citric and lactic acids occurs after removal of the feathers.

7. The method of claim 4 in which the treating of the poultry with the antimicrobial solution of citric and lactic acids occurs after removal of the feathers.

8. The method of claim 3 in which the treating of the poultry with the antimicrobial solution of citric and lactic acids occurs after evisceration.

9. The method of claim 4 in which the treating of the poultry with the antimicrobial solution of citric and lactic acids occurs after evisceration.

10. The method of claim 3 in which the treating of the poultry with the antimicrobial solution of citric and lactic acids occurs after removal of the feathers and again after evisceration.

11. The method of claim 4 in which the treating of the poultry with the antimicrobial solution of citric and lactic acids occurs after removal of the feathers and again after evisceration.

12. The method of claim 3 in which the treating with the antimicrobial solution of citric and lactic acids occurs for about 1 to 60 seconds.

13. The method of claim 4 in which the treating with the antimicrobial solution of citric and lactic acids occurs for about 1 to 60 seconds.

14. The method of claim 3 in which the treating with the antimicrobial solution comprising a blend of citric and lactic acids occurs for about 5 to 10 seconds.

15. The method of claim 4 in which the treating with the antimicrobial solution comprising a blend of citric and lactic acids occurs for about 5 to 10 seconds.
